(19) United States
(12) Patent Application Publication
(10) Pub. No.: US 2006/0075342 A1
(43) Pub. Date: Apr. 6, 2006

(54) Handheld pda video accessory

(75) Inventor: Frank C Penning, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/539,970

(22) PCT Filed: Nov. 28, 2003
(86) PCT No.: PCT/IB03/05539

§ 371 Date: Jun. 19, 2005

Related U.S. Application Data
(60) Provisional application No. 60/434,587, filed on Dec. 18, 2002.

(51) Int. Cl. G06F 17/30

(52) U.S. Cl. 715/704

(57) ABSTRACT

A portable video accessory apparatus (10) is adapted to be mated to a handheld computer (30), such as a personal digital assistant (PDA) (30). The video accessory apparatus (10) adds a video playback and recording functionality to the PDA (30). The video accessory device (10) is capable of controlling the playback and recording of small form factor optical (SFFO) discs thereby causing the PDA (30) to act in the capacity of a ‘smart’ display module. A video engine (12) of the video accessory (10) may be realized with a small form factor optical (SFFO) disc drive capable of playing back optical discs on the order of 25 to 50 mm in diameter. The small form factor video engine (12) is of comparable dimensions to the PDA device (30), allowing the two devices, once mated, to have the look and feel of a single integrated unit.

The present invention relates to a video accessory apparatus attached to a personal digital assistant (PDA).

Personal digital assistants (PDAs) are becoming more popular as they become more powerful and more compact. The handheld units are exploding in popularity for personal as well as business use, as people in fields ranging from information technology and medicine, to sales and maintenance are embracing them. It is estimated that in the next three years, the wireless handheld market will grow to more than one billion users. It is no surprise, therefore, that companies continue to design applications and accessories for these mobile handheld devices.

For example, companies like Handspring™ Corporation of Mountain View, Calif. has introduced a PDA device, i.e., the 8 MB Visor Pro model with expansion slots that allow the Visor Pro to become a digital camera, mobile phone, wireless Internet device and MP3 player. Another example is the TRGpro from HandEra™ Corporation which introduced a popular handheld for big business using the Palm™ operating system. The TRGpro includes such features as a built-in Compact Flash (CF) slot and enhanced audio. The CF slot provides slideshow presentation capabilities. The Compaq Ipaq H3650 pocket PC from Compaq™ Corporation offers two built-in expansion slots for adding memory cards or an input/output device such as an Ethernet card, modem, or a Wi-Fi card. Other add-ons under consideration for future use include GPS packs, cell phone packs, modem packs etc.

As can be seen, the PDA currently provides capabilities for a wide variety of applications in addition to its core functionality. With particular regard to data storage and playback, the PDAs currently provide some means of solid-state storage (e.g., Compact Flash). A disadvantage of these storage solutions is the relatively large cost of the storage media per MByte. By contrast, conventional optical storage provides intrinsically low media cost relative to solid-state storage. Further, third generation optical storage technology based on blue lasers and phase change recording provides storage capacities that far exceed the best that solid-state storage can currently offer. For example, 27 Gbytes is currently possible on a 12 cm optical disc using the Blu-ray standard. Using this data density for a small form factor optical drive (SFFO), a storage capacity of over 1 GBytes becomes feasible on a 3 cm optical disc. Despite the obvious advantages, current PDA designs do not accommodate optical storage media.

Another big advantage optical storage has with respect to other mobile storage solutions like flash and hard disk is the easy and cheap replication of prerecorded content which has made pre-mastered ROM, CD, DVD and video audio CD and DVD the medium of choice for content distribution. Once such small form factor optical storage drives penetrate the market, video and audio prerecorded content on small disks is expected to take a significant market share away from the existing formats.

Accordingly, what is needed is a stand-alone video accessory, capable of utilizing third generation optical storage media, that can be easily interfaced to a PDA for adding a video playback and recording functionality to the PDA.

According to the present invention there is provided a video accessory apparatus adapted to be coupled (mated) to a handheld computer, such as a personal digital assistant (PDA). The video accessory apparatus adds a video playback and recording functionality to the PDA.

According to one aspect of the present invention, the video accessory device is capable of controlling the playback and recording of small form factor optical (SFFO) discs thereby causing the PDA to act in the capacity of a ‘smart’ display module.

According to another aspect, the PDA controls the video accessory, providing signals to initiate and terminate the playing of the SFFO discs.

It is highly desirable that the PDA recognizes when it is mated with the video accessory, allowing the PDA to shift to an accessory control mode wherein the display device is configured to present video information to a user via I/O circuitry in the video accessory.

In a preferred embodiment, a video engine of the video accessory may be realized with a small form factor optical (SFFO) disc drive capable of playing back optical discs on the order of 25 to 50 mm in diameter. The small form factor video engine is of comparable dimensions to the PDA device, allowing the two devices, once mated, to have the look and feel of a single integrated unit.

A more complete understanding of the method and apparatus of the present invention may be had by reference to the following detailed description when taken in conjunction with the accompanying drawings wherein:

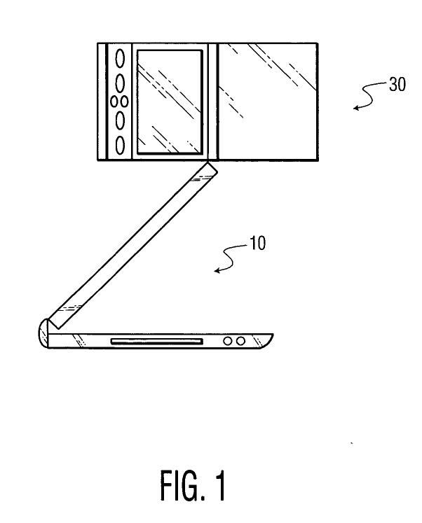

FIG. 1 of the drawings is a perspective view of one embodiment of a Personal Digital Assistant having attached thereto a video accessory apparatus constructed according to the teachings of the present invention and physically and electrically connected to the Personal Digital Assistant;

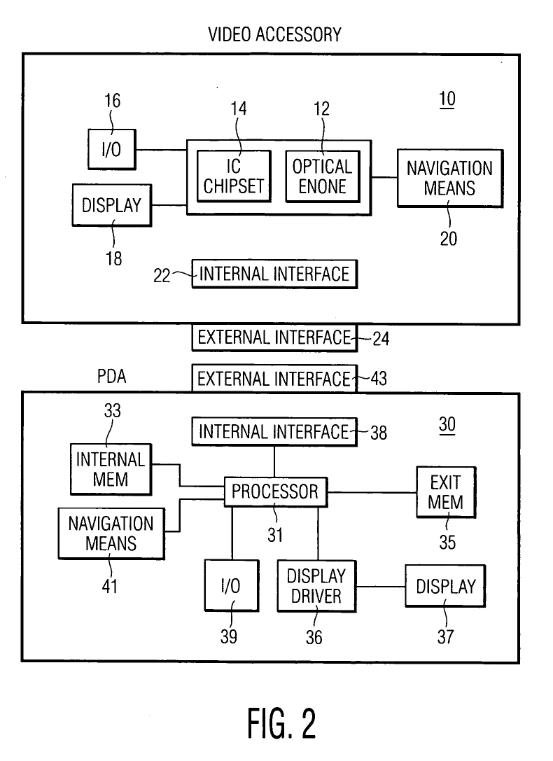

FIG. 2 is a diagram showing different functional blocks in the PDA device and in the video accessory apparatus according to a preferred embodiment of the invention;

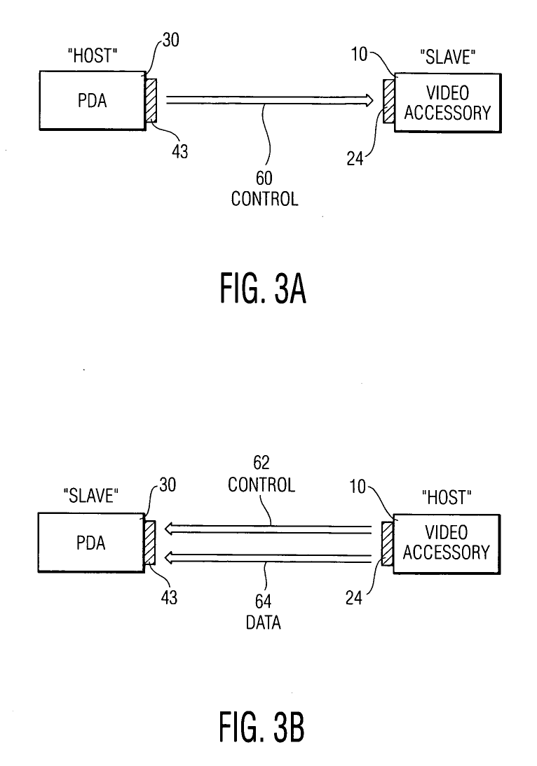

FIG. 3a illustrates a first embodiment for transmitting data between the video accessory apparatus and the PDA; and

FIG. 3b illustrates a second embodiment for transmitting data between the video accessory apparatus and the PDA.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

Turning to FIG. 1, a perspective illustration shows the video accessory apparatus 10 of the present invention in a connected state with a personal digital assistant (PDA) 30. In the embodiments described herein, PDA will mean a standalone portable personal digital assistant unit. It is understood, however, that PDA could in fact represent other handheld computers.

FIG. 2 is a block diagram illustrating components of a PDA device 30 and the video accessory apparatus 10 of the invention in accordance with one embodiment. The PDA device 30 of FIG. 2 is conventional in its hardware content and arrangement.

In the present embodiment, PDA 30 includes a processor 31. The processor 31 is, for example, a micro controller unit (MCU). The processor 31 controls functions including I/O functions (Input/Output) associated with the I/O means 39. The processor 31 is shown coupled to an internal memory 33 and to an external memory 35. The internal memory 33 may correspond to non-volatile memory (e.g., RAM or ROM), and the external memory 35 may correspond to volatile memory (e.g., Flash memory). The processor 31 is coupled to a display driver 36, which configures data to create an image on display device 37 (that is conventionally an LCD screen). PDA device 30 further comprises input/output (I/O) interface 39 which can be a USB 2.0 port or an iLink 1394 port, one or more control buttons that allow a user to control the operations of the PDA device 30 and the video accessory device 10. PDA 30 further includes internal interface 38 which can be, for example, an ATA/ATAPI (IDE) interface, ATAPI Standard interface, SCSI (SCSI Standard) interface or the like.

Another feature of the invention are the dimensions of the video accessory apparatus 10. As shown in FIG. 1, the video accessory apparatus 10 of the invention is preferably of comparable dimensions to the PDA 30, such that when the two devices are mated, they have the look and feel of a single integrated device.

The video accessory apparatus 10 of the invention generally comprises an optical engine 12 embodied as a small-form-factor optical drive (SFFO), with supporting circuitry, for playing back and recording SFFO optical discs having a diameter in the range substantially from 25 mm to 50 mm. The video accessory apparatus 10 of the invention includes an optical engine 12 comprised of an optical light-path, a laser, e.g., a blue laser and a photo-detector. A laser-beam is focused onto a rotating disk using a strong objective lens which is placed in a focusing and tracking actuator. For this purpose, the optical light-path generates focusing and tracking error signals and the high frequency data signal is pre-amplified and hence processed as to generate an error-free bit-stream which can be used by the application. The IC chipset 14 includes, inter alia, the laser driver, actuator driver, spindle motor driver, a processor dedicated to servo functionality and a general processor (e.g., MIPS) for the data-path. The video accessory device 10 further includes I/O interface 16 which can be a USB 2.0 port or an iLink 1394 port. The video accessory apparatus 10 further includes a small display 18 to view commands activated on a limited user interface 20.

A. Interfacing the PDA and the Video Accessory Device

Each device 10, 30 requires an external interface 24, 43 which can be, for example, a Compact Flash (CF) interface, PCMCIA, or the like. Alternatively, external interfaces 24, 43 can also be a proprietary interface, such as a Palm™ or IPaq™ interface. In addition to these standard ‘memory’ interface connections described above, to enable fast data links (e.g., interfaces), interfaces such as i-link (IEEE 1394) or USB2.0 may be used. At present, ninety-percent of digital cameras are equipped with the high-speed i-link interface. It is contemplated that connecting the video accessory device 10 to a digital camera via an i-link interface would enable fast transfers. The present invention also contemplates the use of the USB2.0 interface to enable fast downloads of multi-media content (e.g., movies) from the Internet via a personal computer (PC) equipped with a broadband connection.

As used herein, the term “external interface” is defined to mean that the PDA 30 is externally coupled with the video accessory apparatus 10, utilizing one or more of the interface technologies described above, to effect a logical link such that data interchange is possible between these devices, i.e. any necessary protocol negotiation has been completed and each device, logically/programmatically “recognizes” the presence of the other device.

B. First Operational Embodiment

The video accessory apparatus 10 can be freely connected to (and disconnected from) the PDA 30, thus making it possible for the video accessory apparatus 10 and the PDA device 30 to easily communicate with each other when connected.

FIG. 3a illustrates a first embodiment for transmitting data between the video accessory apparatus 10 and the PDA 30. To initiate a data transfer, the control unit 31 of the PDA 30, acting as host, issues control commands 60 to the video accessory apparatus 10 to read or write (R/W) a certain block or blocks of information.

The present embodiment is considered a conventional use of the combined apparatus in that the video accessory apparatus 10 acts as a “slave” unit performing functions (e.g., read, write) which are responsive to control commands issued by the host PDA 30.

In this embodiment, navigation means 41 of PDA 30 is activated to allow a user to execute the desired control functions for controlling the video accessory apparatus 10 such, for example, “Play”, “Rewind”, “Fast-Forward”, “Stop” and “Record”. Furthermore, as a consequence of navigation means 41 of the PDA 30 being activated, the navigation means 20 of the video accessory device 10 become de-activated.

In the present embodiment, external interface 24 of the video accessory apparatus 10 may be any standardized interface. For example, external interface 24 may implemented as a compact flash (CF) interface, or a PCMCIA interface.

C. Second Operational Embodiment

FIG. 3b illustrates an alternate embodiment for transmitting data between the video accessory apparatus 10 and the PDA 30. In accordance with the present embodiment, the video accessory apparatus 10 acts as the host and the PDA 30 acts as a “slave” device. In the present embodiment, navigation means 20 of the video accessory apparatus 10 is activated to allow a user to execute the desired control functions for controlling the PDA device 30 such, for example, “Play”, “Rewind”, “Fast-Forward”, “Stop” and “Record”. Furthermore, as a consequence of navigation means 20 of the video accessory device 10 being activated, the navigation means 20 of the video accessory device 10 become de-activated. In the present embodiment the PDA 30 merely serves as a ‘smart’ display to the host video accessory apparatus 10.

As shown in FIG. 3b, the control commands 62 are issued from the video accessory apparatus 10 to the PDA 30 through interfaces 23 and 43. In the present embodiment, there is a data flow 84 from the video accessory 10 to the PDA 30 whereby the PDA 30 receives the multi-media data from the video accessory 10 for display thereon.

Although the present invention and its advantages have been described in detail, it should be understood that various changes, substitutions and alterations can be made herein without departing from the spirit and scope of the invention as defined by the appended claims.

In short, a video accessory has been disclosed which interfaces with handheld computers (e.g., PDAs) with a minimum of effort. The video accessory provides the handheld computer with a video playback/recording capability.

The foregoing is to be constructed as only being an illustrative embodiment of this invention. Persons skilled in the art can easily conceive of alternative arrangements providing functionalities similar to this embodiment without any deviation from the fundamental principles or the scope of this invention.

1. A video accessory (10) for use with a hand-held computer (30), said accessory (10) comprising:
means for playback and recording of small form factor optical (SFFO) discs; and
means for mating said video accessory (10) with said hand-held computer (30);
wherein said video accessory (10) is of comparable dimensions with said hand-held computer (30).

2. The video accessory (10) of claim 1, wherein said means for mating further comprises recognition means for recognizing when said video accessory (10) is mated to said hand-held computer (30).

3. The video accessory (10) of claim 1, further comprising navigation means (20) for controlling a combination of said video accessory (10) and said hand-held computer (30).

4. The video accessory (10) of claim 1, wherein said (SFFO) discs are on the order of 25 to 50 millimeters in diameter.

5. A video accessory (10) for use with a hand-held computer (30), said accessory (30) comprising:
a processor for controlling the operations of the video accessory (10);
an optical engine (12) coupled to said processor and configured to play small form factor optical (SFFO) discs;
an integrated circuit (IC) chipset (14);
input/output interface means (16)
navigation means (20) coupled to said processor, configured to allow a user to control a display said hand-held computer (30) and operations associated with said video accessory (10); and
internal interface means (22).

6. The video accessory (10) of claim 5, wherein said input/output interface means (16) is one of a USB2.0 port and an iLink.

7. The video accessory (10) of claim 6, wherein said ilinK is operated in accordance with an institute of electrical engineer (IEEE) standard.

8. The video accessory (10) of claim 5, wherein said navigation means (20) comprises one or more control buttons for controlling hand-held computer (30) operations.

9. The video accessory (10) of claim 5, wherein said internal interface (22) is one of an ATA/ATAPI (IDE) interface, an ATAPI Standard interface and a SCSI (SCSI Standard) interface.

10. The video accessory (10) of claim 5, wherein said video accessory (10) is of comparable dimensions to said hand-held computer (30).

11. The video accessory (10) of claim 5, wherein said hand-held computer (30) is a personal digital assistant (PDA).

12. The video accessory (10) of claim 5, wherein said optical engine (12) is comprised of an optical light-path, a blue laser and a photo-detector.

13. The video accessory (10) of claim 5, further comprising a housing for accommodating said processor, said optical engine (12) including at least one of said discs, said IC chipset (14), said display means (18), said input/output interface means (16).
